(19) United States
(12) Patent Application Publication
(10) Pub. No.: US 2012/0249775 A1
(43) Pub. Date: Oct. 4, 2012

(54) OPTICAL NAVIGATION ATTITUDE DETERMINATION AND COMMUNICATIONS SYSTEM FOR SPACE VEHICLES

(75) Inventors: Michael Adam Paluszek, Princeton, NJ (US); Gary Alan Pajer, Yardley, PA (US)

(73) Assignee: Princeton Satellite Systems, Plainsboro, NJ (US)

(21) Appl. No.: 13/435,569

(22) Filed: Mar. 30, 2012

Related U.S. Application Data
(60) Provisional application No. 61/469,391, filed on Mar. 30, 2011.

(51) Int. Cl. H04N 7/18

(52) U.S. Cl. 348/117; 348/E07.085

(57) ABSTRACT

The invention is for a sensor for use in spacecraft navigation and communication. The system has two articulated telescopes providing navigation information and orientation information as well providing communications capability. Each telescope contains a laser and compatible sensor for optical communications and ranging, and an imaging chip for imaging the star field and planets. The three optical functions share a common optical path. A frequency selective prism or mirror directs incoming laser light to the communications and ranging sensor. The Doppler shift or time-of-flight of laser light reflected from the target can be measured. The sensor can use the range and range rate measured from the incoming laser along with measurements from the imaging chip to determine the location and velocity of the spacecraft. The laser and laser receiver provide communications capability.

### CROSS REFERENCE TO RELATED APPLICATIONS

This application is related to, and claims priority from, U.S. provisional application 61/469,391 filed on Mar. 30, 2011 by Michael A. Paluszek entitled “OPTICAL NAVIGATION ATTITUDE DETERMINATION AND COMMUNICATIONS SYSTEM FOR SPACE VEHICLES, the contents of which are hereby incorporated herein by reference.

### STATEMENT REGARDING FEDERALLY SPONSORED RESEARCH OR DEVELOPMENT

This invention was made with government support under Contract No. NNX08CA26C awarded by the National Aeronautics and Space Administration. The Government has certain rights in the invention.

### FIELD OF THE INVENTION

The present invention relates to the navigation of spacecraft, the pointing of spacecraft and the communication with other spacecraft.

### BACKGROUND OF THE INVENTION

Spacecraft require communications with the earth or other spacecraft and need navigation information to control their orbits. Spacecraft also need to be oriented in space.

Absolute navigation is generally currently done using radio links to the ground. The range and range rate of the spacecraft is measured and these measurements are incorporated by a filter. Since the measurements are one dimensional, many measurements over extended periods of time must be taken. As a consequence, radio link navigation is expensive. Deep space spacecraft use the Deep Space Network for this purpose, and time on the Deep Space Network is limited and expensive, making navigation a major operations cost. In the event of a disruption of radio transmission, radio link navigation fails.

For satellites in the vicinity of the earth, the Global Positioning Satellite system (GPS) may be used. In the event of a failure of the GPS system, or for satellites out of range of the GPS system, GPS navigation fails.

Currently attitude determination is done with dedicated optical sensors fixed to the body of the spacecraft. Since the sensor is fixed, it many be subject to illumination from the sun or a nearby planet making attitude determination impossible. (U.S. Pat. No. 4,621,329 by Jacob; U.S. Pat. No. 4,658,361 by Kosaka et al; U.S. Pat. No. 5,546,309 by Johnson; U.S. Pat. No. 5,963,166 by Kamel; U.S. Pat. No. 6,253,125).

Communications between spacecraft is done using radio frequency links. For example, the Iridium constellation forms a network with radio frequency links. The NASA TDRS satellite also provides inter-satellite links.

Autonomous navigation by means of optical imaging of the sun, earth, and moon has been disclosed. See, for example, U.S. Pat. No. 5,109,346 by Wertz. Wertz, however, does not integrate communication functions, and does not disclose the use of planets, asteroids, minor planets, or satellites for navigation. Also, Wertz would not work outside of Earth orbit.

Autonomous navigation of satellites in Geosynchronous Earth Orbit (GEO) by means of the GPS system has also been disclosed. See, U.S. Pat. No. 7,860,617 to Gaylor et al. Gaylor, et al.'s system does not incorporate communication functions, and will not operate if the satellite is out of range of GPS, which is always true in deep space trajectories, or if the GPS system fails. Systems that integrate communication and navigation functions have been disclosed that require input from external satellites or ground stations, use radio for communication, and do not employ shared multi-purpose hardware. See, for example, U.S. Pat. No. 5,617,100 to Akiyoshi et al; and U.S. Pat. No. 6,721,658 to Stadter et al).

Systems that integrate communication and navigation functions have been disclosed that require input from external satellites or ground stations, use radio for communications, and do not employ shared multi-purpose hardware. See, example, U.S. Pat. No. 5,617,100 to Akiyoshi et al; and U.S. Pat. No. 6,721,658 to Stadter et al.

Systems that use shared optical paths but different wavelengths for different functions have been disclosed for various applications including navigation, but they do not incorporate communication functionality. See, for example, U.S. Pat. No. 7,049,597 to Bodkin; and U.S. Pat. No. 8,081,302 to Paluszek et al).

### SUMMARY OF THE INVENTION

Provided are a method and system for spacecraft navigation and spacecraft communications. Three optical technologies are consolidated into one device, sharing a common set of optical components, capable of performing navigation and communication functions. The three technologies are navigation by the imaging of solar system objects, navigation by laser ranging (LIDAR), and communication by laser-generated carrier. Two articulated telescopes are employed. Each telescope has two rotational degrees of freedom and the two telescopes are mounted on a platform having a single rotational degree of freedom. Each telescope comprises a lens, imaging chip, frequency selective beam splitter, a laser, a laser modulator, and a laser receiver. The laser receiver services both the communication subsystem and the ranging subsystem.

Means for measuring range and range rate using Doppler interferometry or optical pulse time-of-flight measurements are also provided in embodiments.

This invention is distinguished from, and improves upon prior art at least in one or more of the following respects:
1. A single apparatus with shared optical path provides both navigation and communication functions.
2. The shared optical path employs different wavelengths for different functions.
3. The navigation function is entirely autonomous, requiring input data from no outside source other than the data obtained by its own optical system.
4. No link to the earth is required.
5. Does not require the GPS system.
6. Uses an Unscented Kalman Filter in the processing of data.
7. The communication link is a directed laser beam in contrast to a radio link.

For the ranging subsystem, the laser generates an optical beam suitable for one of several possible ranging techniques. The beam is directed through one or both of the telescopes toward a target object. The receiver collects the light that has been generated and subsequently reflected from a target object. The processing system then processes the collected light to obtain range and range rate information of the target. The means to accomplish such processing can be provided by various techniques including pulsed laser time-of-flight measurements and coherent detection of the Doppler shift of the light, but the invention is not limited to these two examples.

The same laser/receiver subsystem also functions as an optical communication system. The laser provides the optical carrier, and the modulator impresses information onto the carrier using one of many well-known techniques such as direct current modulation or electro-optic modulation. The receiver collects the carrier arriving from some communication transmission source and performs demodulation and decoding in order to recover the transmitted information.

In addition to their use in the ranging and communication subsystems, the telescopes are also used to collect light for optical navigation. For this purpose, the telescopes point at celestial targets including but not limited to the earth, the moon, the planets, asteroids, comets, and man-made objects. The images are processed to obtain orientation information and navigation information. The data from the imaging chips is combined with the data from the laser ranging system to obtain navigation information.

### BRIEF DESCRIPTION OF THE DRAWINGS

FIG. 1 is a block diagram of an embodiment of the invention.

FIG. 2 shows a detail of the telescope.

FIG. 3 shows a block diagram of data flow and processing.

FIG. 4 shows the overview of earth and satellites.

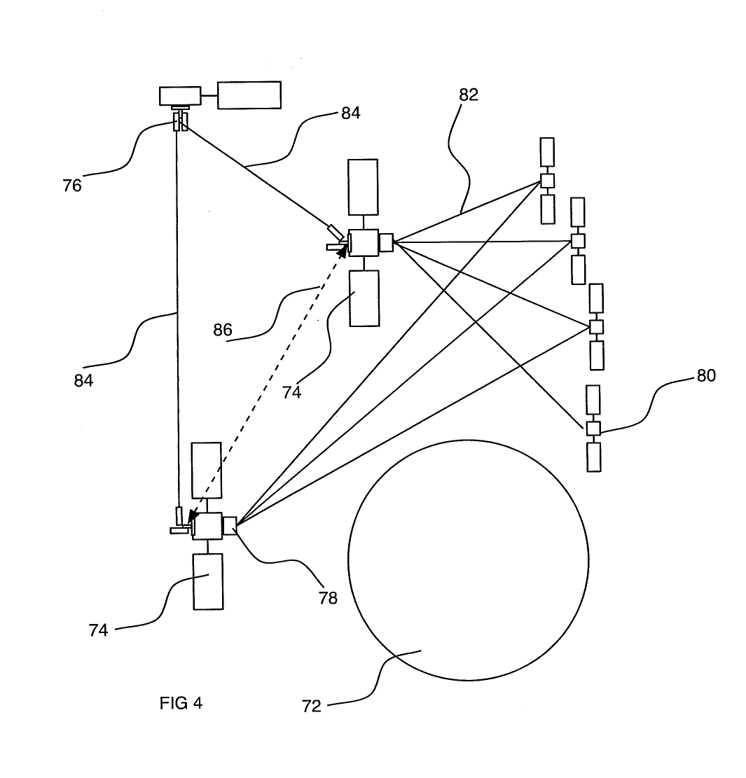

### DETAILED DESCRIPTION

In the following description, for purposes of explanation, specific numbers, materials and configurations are set forth in order to provide a thorough understanding of the invention. It will be apparent, however, to one having ordinary skill in the art, that the invention may be practiced without these specific details. In some instances, well-known features may be omitted or simplified so as not to obscure the present invention. Furthermore, reference in the specification to “one embodiment” or “an embodiment” means that a particular feature, structure or characteristic described in connection with the embodiment is included in at least one embodiment of the invention. The appearances of the phrase “in an embodiment” in various places in the specification are not necessarily all referring to the same embodiment.

The present invention advantageously provides a method and system that allows for a sensor that provides communications, navigation data and orientation data.

During the course of this description like numbers will be used to identify like elements according to the different views, which illustrate the invention.

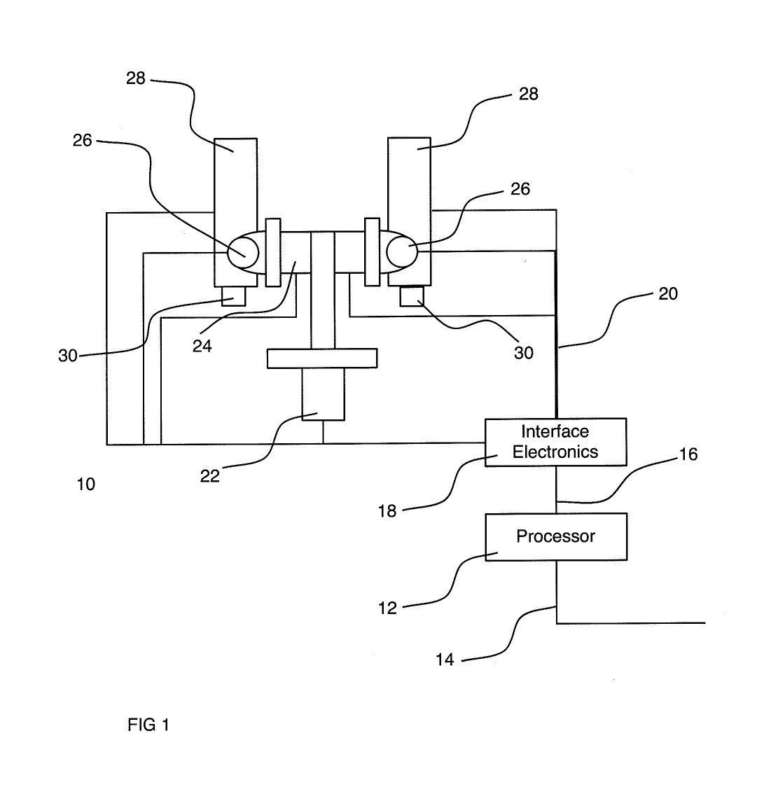

A system embodiment is shown in FIG. 1. This diagram shows various components of the sensor 10.

A processor board 12 reads in all of the sensor measurements and processes the incoming data to produce the navigation and attitude estimates and communications data. The board, 12, also sends signals to the motors to point the telescopes. An interface cable 14 provides a physical data link to the rest of the spacecraft (not depicted). The link may use any one of a number of interface standards including SpaceWire and RS-422. Cables 16 connect the processor board to the interface electronics board 18, which contains the electronics that read in the images from the telescopes, the measurements and communications data from the laser receivers, the measurements from the angle encoders which provide the orientation of the telescope, and the measurements from the inertial measurement unit 28. The board 18 also sends control signals to the motors. Flexible cables 20 connect the interface board to the telescopes. The rotation of the telescope is limited so that the cables to not become tangled. The platform motor and angle encoder 22 rotates the entire telescope platform and provides data as to the platform orientation. A azimuth motor and its encoder 24 controls the azimuth of each telescope and provides data as to the telescope orientation. Each telescope has its own azimuth motor and encoder 24.

The elevation motor 26 and its encoder controls the elevation of each telescope and provides data as to the telescope orientation. Each telescope has its own elevation motor 26.

The telescope 28 contain all of the imaging components, the laser and the receiver. An inertial measurement unit 30 is attached to the base of each telescope 28. It measures angular rates and linear accelerations.

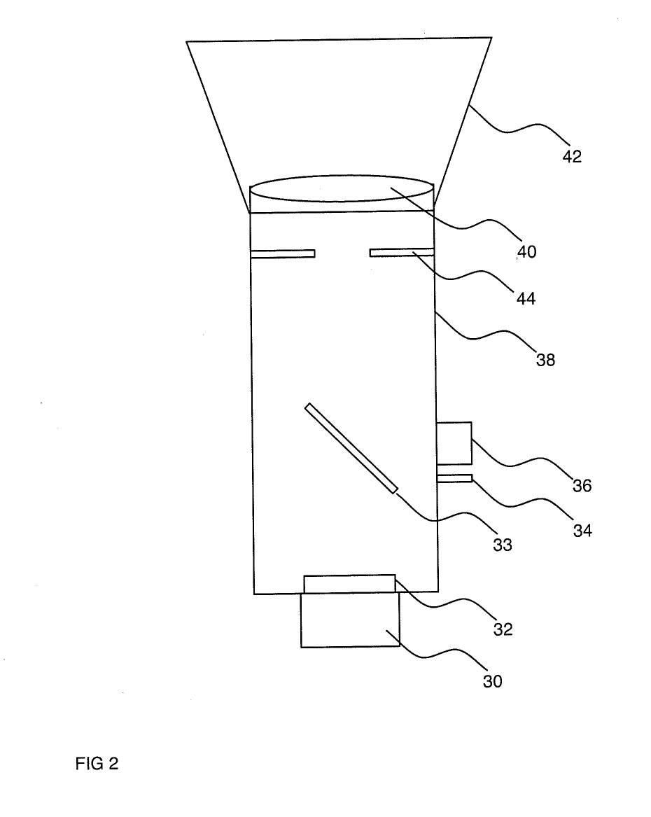

Turning now to FIG. 2, which shows the interior of each telescope and its components, the imaging chip 32 is a two-dimensional array of pixels that measures the incoming light. The chip 32 may be of one of many types including CMOS (Complementary Metal Oxide Semiconductor), CCD (Charge Coupled Device) or APS (Active Pixel Sensor).

A beam splitter 33 is provided, which splits the incoming light and separates the frequencies for the laser communications and laser ranging. Communication and ranging light is directed by the beam splitter 33 away from the imager and into the receiver 36. The beam splitter can reflect a narrow band of frequencies around the frequency of the generated light, passing the remainder to the imager 32. Alternatively, the beam splitter 33 can reflect all frequencies less than or nearby the frequency of the generated laser light, passing the remainder to the imager 32. The former approach would be used if the frequency of the generated light falls within the sensitive range of the receiver, while the latter approach is an option when the generated laser light is at a frequency less than the low-frequency cut-off of the sensitivity of the imager 32.

The laser subsystem 34 comprises a laser, a means to modulate the intensity of the generated light, means to collimate the generated light, and means to deliver a small fraction of the generated light to the receiver 36 for reference purposes. The laser subsystem generates beams of light that are used for communication and laser ranging. In an embodiment, the temporal characteristics of the beam differ depending on which function is being employed. The laser subsystem has the capability and control systems needed to produce the appropriate beam for each function. The functions are not carried out simultaneously. The laser is typically a semiconductor laser similar to those used for terrestrial optical communication, but there are many types of laser that can perform the function, and the invention is not limited to any particular type of laser or laser system.

The laser receiver 36 detects both the incoming laser radiation used for communication, and the incoming light used for laser ranging. When used for communication, the receiver will employ any of the many well-know methods for receiving optical communication signals. When used for laser ranging, the detector will use a sample of the generated light for comparison, and implement one of the many time-of-flight detection methods, or one of the many detection methods for measuring Doppler shift.

A telescope shaft 38 provides support for the components. It also contains baffles for limiting stray light within the telescope barrel. A lens 40 directs incoming light to the sensors. The lens 40 may be of any type but most typically would be an opochromatic multi-element aspherical lens to minimize aberrations. The stray light shade 42 may be used to block stray light. The aperture stop 44 varies the aperture size so that the telescope can be directed at very bright targets like the sun.

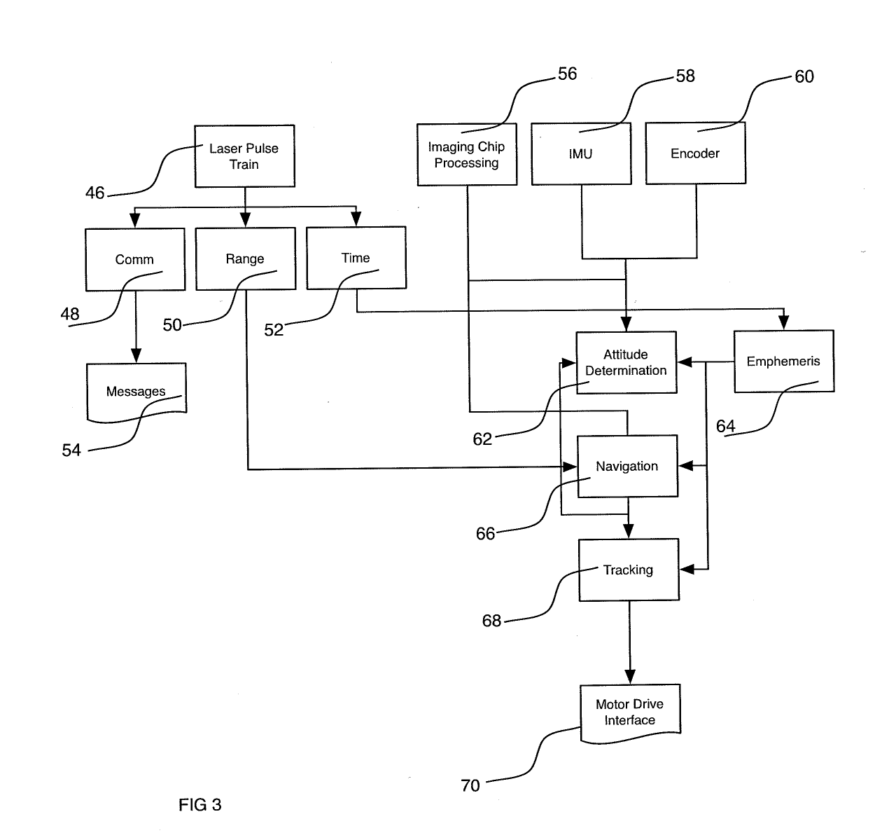

FIG. 3 is a block diagram showing the flow and relationships among data signals and control signals. In an implementation, raw data from the laser receiver is recorded in 46, and the communication pulses are read 48 by the communications software, which performs error correction and sends 54 the resulting messages on the external data bus. The range and range rate is measured 50 by Doppler or time-of-flight techniques. Time is computed 52 from the time data in the message, the time of transit of the message and the range data.

The imaging software on an imaging processor 56 reads the frames sent from the camera chip and performs corrections for image noise, dark current and other factors.

Next Inertial Measurement Unit (IMU) interface software reads the data from the IMU 58, and the angle encoder 60 interface software reads the raw angle encoder outputs and converts them to angles.

In a preferred embodiment, attitude determination software 62 employs an Unscented Kalman Filter (UKF) to perform stellar attitude determination. The recursive navigation system also employs an Unscented Kalman Filter. The Unscented Kalman Filter (UKF) is able to achieve greater estimation performance than the Extended Kalman Filter (EKF) through the use of the unscented transformation (UT). It is common to both the attitude determination and recursive navigation algorithms. The UT allows the UKF to capture first and second order terms of the nonlinear system. Unlike the EKF, the UKF does not require any derivatives or Jacobians of either the state equations or measurement equations. Furthermore, in contrast to the EKF, with the UKF it is not necessary to numerically integrate the covariance matrix.

The star, planet and object catalog and ephemeris is contained in block 64. The ephemeris provides references for attitude determination and navigation. Navigation software 66 uses the UKF to compute the position and velocity of the spacecraft. The UKF uses angles between planets and stars, angles between planets, chord widths of planetary disks and angles between landmarks on planetary surfaces.

Tracking software 68 determines where to point the telescopes using a motor, drive interface 70. The tracking targets are chosen to minimize the navigation errors.

The overall configuration of satellites in orbit in an embodiment is shown in 4. A target satellite 76 including the inventive system and method orbits planet Earth 72. Two relay satellites in low Earth orbit are shown 74 and GPS satellites are also represented 80. The relay satellites 74 receive GPS data at their radio frequency (RF) receivers 78 via RF links 82. The relay satellites 74, also include the inventive system and method, or optionally for interplanetary or deep-space missions, a more powerful laser and a more sensitive receiver. Either way, a relay satellite 74 creates an optical link 84 to target satellite 76 by means of an optical navigation system on the target satellite. The target satellite 76 could be in geosynchronous Earth orbit, interplanetary orbit or deep-space orbit. The optical link 84 provides means for communication and for the establishment of range and range rate data as described above. Intersatellite links 86 allow for interferometric methods to be employed for enhanced measurement accuracy.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An optical navigation, attitude determination and communications system comprising:
two telescopes, each comprising a single objective lens, an imager comprising an imaging chip, a frequency selective beam splitter, a laser, a laser modulator, a laser demodulator, a laser receiver and a laser transmitter, the single objective lens in each telescope providing a common optical path for multiple functions;
the modulator and demodulator providing for the laser communications;
a computer to process the data from the imaging chips and laser receiver; and,
processing software to compute the inertial attitude and absolute orbit.

2. The system of claim 1 further comprising means for measuring range and range rate using Doppler interferometry.

3. The system of claim 1 further comprising means for measuring range and range rate using optical pulse time-of-flight measurement.

4. The system of claim 1 in which the telescopes are articulated.

5. The system of claim 4 in which the telescopes have five degrees of articulation.

6. The system of claim 1 in which the processing software is an Unscented Kalman Filter.

7. The system of claim 1 in which laser frequencies of the lasers are chosen to be outside the bandwidth of the imaging chip so that a beam splitter is not needed.

8. The system of claim 1 in which the system software can perform attitude and orbit determination relative to another spacecraft, planet, minor planet, asteroid, planetary satellite, or the sun.

9. A method for determining both communications, navigation and ranging from a single optical path, the method comprising:
receiving, by a laser receiver of two telescopes, incoming light;
splitting, by a frequency selective beam splitter, the incoming light into a first component light and a second component light, the first component light to be directed to an imager, the second component light to be further split into a first sub-component light and a second sub-component light, the first sub-component light to be directed to a communications receiver, the second sub-component light to be directed to a ranging receiver;
extracting navigation information from the first component light by the imager;
extracting communication signals from the first sub-component light by the communications receiver; and
extracting ranging information from the second sub-component light by the ranging receiver.

10. The method of claim 9, wherein the extraction of ranging information further comprises use of Doppler interferometry.

11. The method of claim 9, wherein the telescopes are articulated.

12. The method claim 11, wherein the telescopes have five degrees of articulation.

13. The method of claim 9, in which the extracting communication signals employs an Unscented Kalman filter.

14. The method of claim 9, wherein the splitting of the incoming laser light is performed by selection of laser light frequencies to be outside the bandwidth of the imager.
